(19) United States
(12) Patent Application Publication
(10) Pub. No.: US 2009/0079722 A1
(43) Pub. Date: Mar. 26, 2009

(54) PLASMA DISPLAY DEVICE

(76) Inventors: Makoto Onozawa, Miyazaki (JP); Hideaki Ohki, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/913,204

(22) PCT Filed: Aug. 4, 2005
(86) PCT No.: PCT/JP2005/014347

§ 371 Date: Oct. 31, 2007

(51) Int. Cl. G09G 5/00; G09G 3/28

(52) U.S. Cl. 345/212; 345/60

(57) ABSTRACT

Provided is a plasma display device, in which a brightness difference caused in a plasma display panel of a large screen is reduced. In order to reduce the value of a streaking or a brightness difference on the plasma display panel screen and to reduce the brightness difference between the central portion and the two end portions of the screen, the plasma display device comprises current limiting means (8x) is interposed for each X-electrode between the X-electrode and an X-electrode drive circuit (3), and current limiting means (8y) is interposed for each Y-electrode between the Y-electrode and a Y-electrode drive circuit (4).

### TECHNICAL FIELD

The present invention relates to a plasma display device. To be more precise, preferred embodiments of the present invention provide a plasma display device, in which a brightness difference caused in a plasma display panel of a large screen is reduced.

### BACKGROUND ART

In a conventional plasma display device, an inputted video signal is processed in a signal processing circuit 1, and is supplied to a drive control circuit 2 as shown in FIG. 4. In the drive control circuit 2, control signals that are supplied to an X-electrode drive circuit 3, a Y-electrode drive circuit 4, an address electrode drive circuit 5 and a scan circuit 6 are formed based on output signals of the above described signal processing circuit 1. The above described respective drive circuits and the scan circuit 6 supply drive pulses to a plasma display panel 7 based on the above described control signals.

In the plasma display device including a large screen of the large-sized plasma display panel 7, it is important to make the brightness of the entire screen uniform so that nonuniformity in brightness does not occur on the screen.

Patent Document 1 discloses a method for reducing a brightness difference by dividing X-electrodes and Y-electrodes into a plurality of blocks and causing the border portions between the blocks to intersect one another.

In FIG. 1 of the Patent Document 1, a plurality of sustain electrodes of the PDP are sectioned into a plurality of blocks. Some of sustain electrodes of the respective blocks are disposed between the sustain electrodes of other blocks in the border portions of a plurality of blocks. A plurality of sustain drivers are connected to the sustain electrodes of the corresponding blocks.

### Patent Document 1: Japanese Patent Laid-Open Publication No. 2000-284747

### DISCLOSURE OF THE INVENTION

When a pattern shown in FIG. 5 is displayed in the plasma display device shown in FIG. 4, a difference may occur between brightness S1 that is brightness of an area of white display sandwiched between black displays on the screen and brightness S2 that is brightness of an area of white display with two ends of white display.

The brightness difference will be called a streaking. A streaking is defined by the following formula.

Streaking=(brightness S1-brightness S2)/brightness S1×100 (%)

The conventional plasma display device has the problem that the value of the above described streaking is large, and it is an important object for improving the image quality to reduce the value of the streaking. In the conventional plasma display device having a large value of a streaking, a voltage drop occurs in the sustain voltage waveform shown in FIG. 6, and the peak value becomes large in the sustain current waveform. It is found out as a result of measurement that when the voltage drop is large, the value of a streaking also becomes large.

Further, the conventional plasma display device has the problem of occurrence of a difference in brightness between the two end portions and the central portion of the plasma display panel screen. The reason of the occurrence of the bright difference will be described by using FIGS. 7 and 8.

FIG. 7 is a diagram of modeling five cells arranged in a lateral direction of the plasma display panel 7. When a discharge current passing between the X-electrode and the Y-electrode is assumed to be equal in each luminous cell in FIG. 7 and a trial calculation is made, expression can be made as follows:

I1=5*I

I2=4*I

I3=3*I

I4=2*1

I5=I

I6=I

I7=2*I

I8=3*I

I9=4*I

I10=5*I

When resistances Rp between the cells are assumed to be equal and a trial calculation is made, a voltage Vsy of the Y-electrode and a voltage Vsx of the X-electrode in each of cells A to E are expressed as follows:

VAy=Vs

VBy=VAy−Rp*I2=Vs−4RpI

VCy=VBy−Rp*I3=Vs−7RpI

VDy=VCy−Rp*I4=Vs−9RpI

VEy=VDy−Rp*I5=Vs−10RpI

VEx=0

VDx=VEx+Rp*I9=4RpI

VCx=VDx+Rp*I8=7RpI

VBx=VCx+Rp*I7=9RpI

VAx=VAx+Rp*I6=10RpI

From the above, when Vd=10RpI, the difference (Vsy-Vsx) of the voltage Vsy of the Y-electrode and the voltage Vsx of the X-electrode in the cells A to E can be expressed as follows:

VAy−VAx=Vs−10RpI=Vs−Vd

VBy−VBx=Vs−13RpI

VCy−VCx=Vs−14RpI

VDy−VDx=Vs−13RpI

VEy−VEx=Vs−10RpI=Vs−Vd

When the relationship is plotted in a graph, the graph is as shown in FIG. 8. FIG. 8 shows that the voltage (Vsy-Vsx) at the time of discharge between the X-electrode and the Y-electrode in each of the cells is low in the central portion of the screen and is high at the two ends of the screen. When the number of cells is large, the brightness in the screen center where the discharge voltage is small is similarly low, and the brightness at the two ends of the screen where the discharge voltage is large is high.

As the conventional example in which the brightness difference on the screen is reduced, the method disclosed in the above described Patent Document 1 is cited, but the above described conventional example has an object to reduce the brightness difference between the lines, and does not have consideration to a solution to the two problems of the above described streaking, and the above described bright difference between the central portion and the two end portions of the screen.

An object of the present invention is to reduce a value of the above described streaking as well as a brightness difference between the central portion and the two end portions of the screen.

In order to attain the above described object, a plasma display device of the present invention has the most main characteristic that current limiting means 8x and 8y is interposed for each X-electrode between the X-electrode and an X-electrode drive circuit 3, and current limiting means 8x and 8y is interposed for each Y-electrode between the Y-electrode and the Y-electrode drive circuit 4.

According to the present invention, a value of a streaking can be reduced, and a brightness difference between the central portion and the two end portions of the screen can be reduced.

### BRIEF DESCRIPTION OF THE DRAWINGS

FIG. 1 is a diagram of an embodiment of a plasma display device of the present invention;

FIG. 2 is a diagram showing the effect of reducing a streaking of the plasma display device of the present invention;

FIG. 3 is a diagram showing the effect of improving a voltage drop by internal resistance of the plasma display device of the present invention;

FIG. 4 is a diagram showing a conventional example of the plasma display device;

FIG. 5 is a diagram showing a problem of a streaking of the plasma display device of the conventional example;

FIG. 6 is a diagram showing a voltage drop of the sustain voltage corresponding to a streaking and occurrence of a peak value of a sustain current;

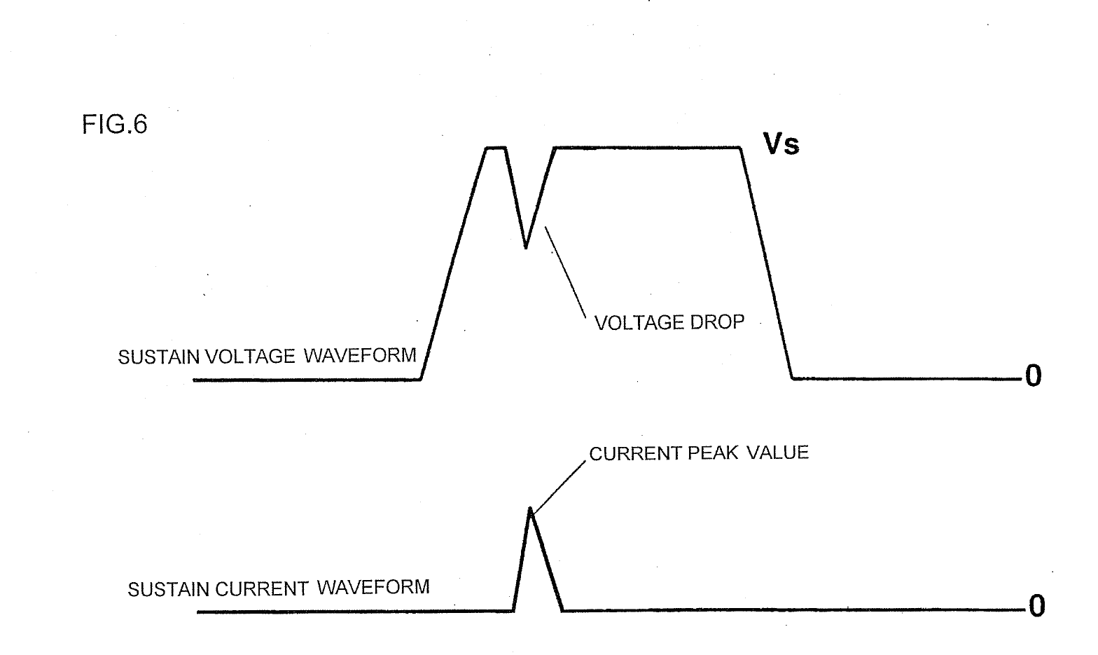

FIG. 7 is a diagram showing occurrence of a voltage drop by internal resistance of the plasma display device of the conventional example; and

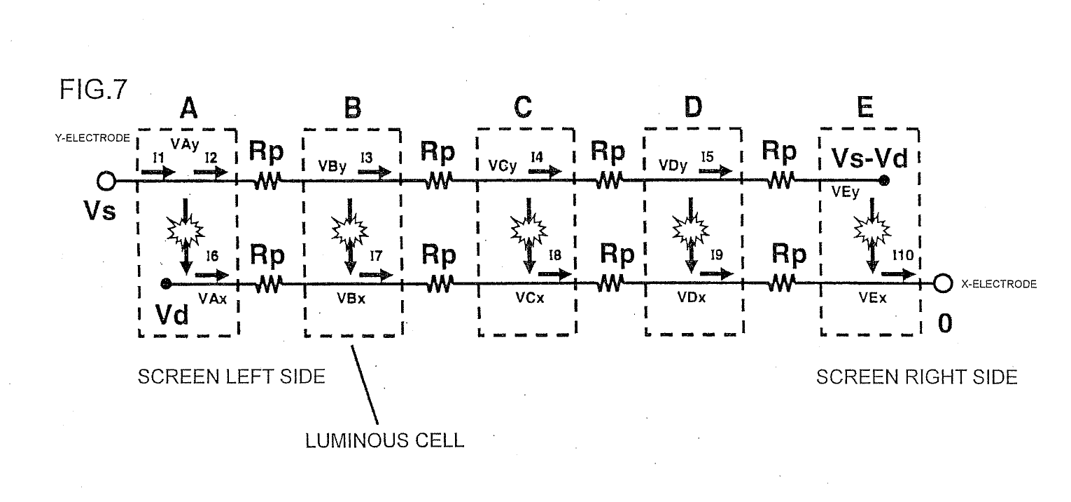

FIG. 8 is a diagram showing a problem of a voltage drop by the internal resistance of the plasma display device of the conventional example.

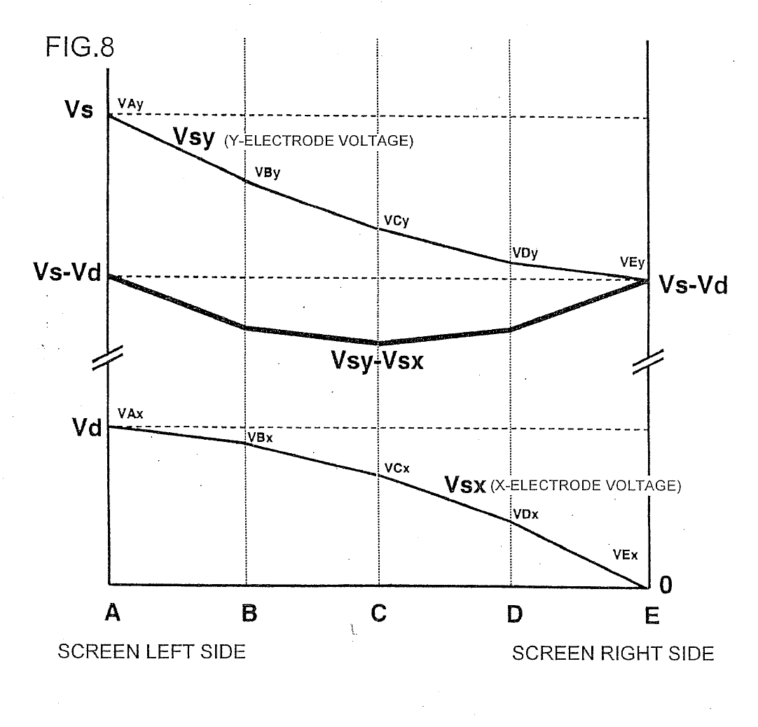

### DESCRIPTION OF SYMBOLS

1 Signal processing circuit

2 Drive control circuit

3 X-electrode drive circuit

4 Y-electrode drive circuit

5 Address electrode drive circuit

6 Scan circuit

7 Plasma display panel

8 Current limiting means

9 Scan drive module (SDM)

10 X-electrode relay board (X-BB)

### BEST MODE FOR CARRYING OUT THE INVENTION

Hereinafter, embodiments of the present invention will be described by using the drawings.

### First Embodiment

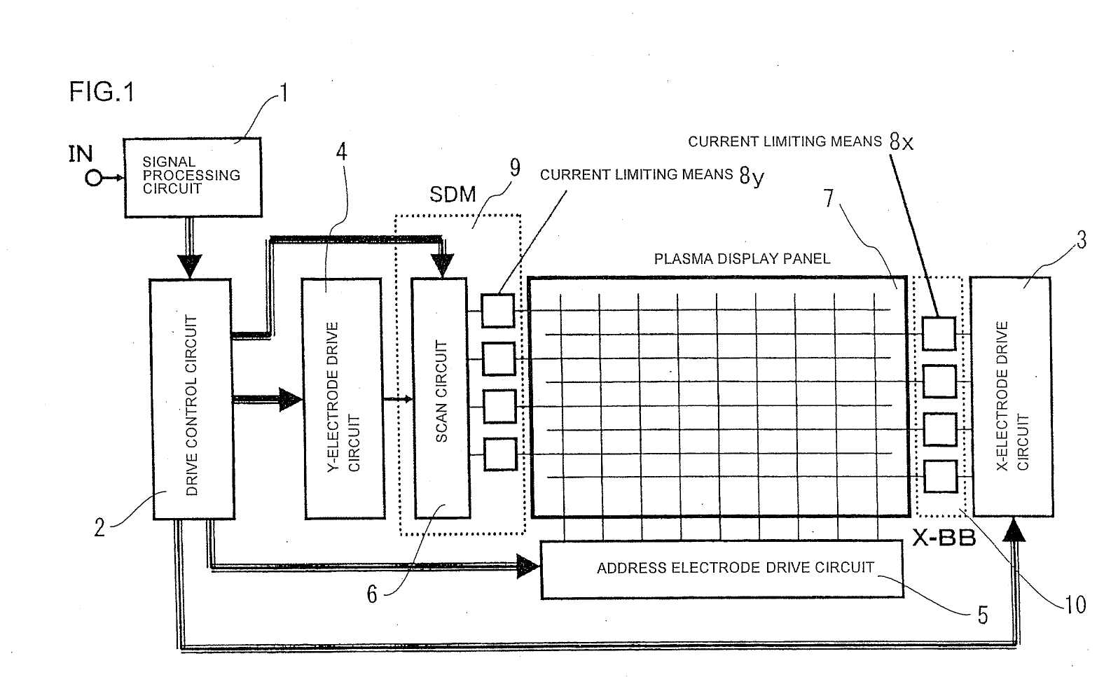

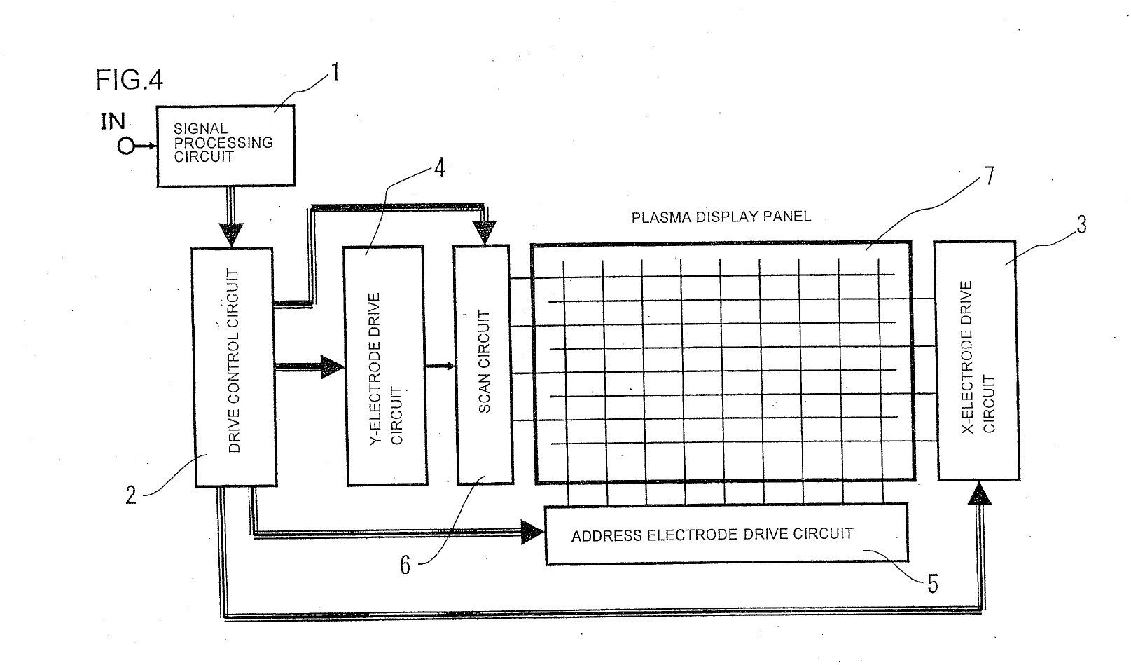

FIG. 1 is a diagram showing a first embodiment when the present invention is applied to an AC type plasma display device. In FIG. 1, as compared with a conventional example of FIG. 4, the different point is that current limiting means 8x or 8y is provided for each electrode. The current limiting means 8x and 8Y is each composed by using a resistor or the like.

In the circuit shown in FIG. 1, the above described current limiting means 8y is connected to the Y-electrode, and the above described current limiting means 8y for the Y-electrode is formed on a scan drive module SDM 9 (Scan Drive Mojule) loaded with a scan circuit 6. The current limiting means 8x composed by using a resistor or the like is formed on a relay board X-BB (X-Broadcast board) 10 connected to the X-electrode as 8x. Here, the current limiting means 8x and 8y each has the same value, for example, the same resistance value.

By using the above described current limiting means 8x and 8y, the peak value of a sustain current which is passed in a sustain period is reduced, and the voltage drop of a sustain voltage can be reduced.

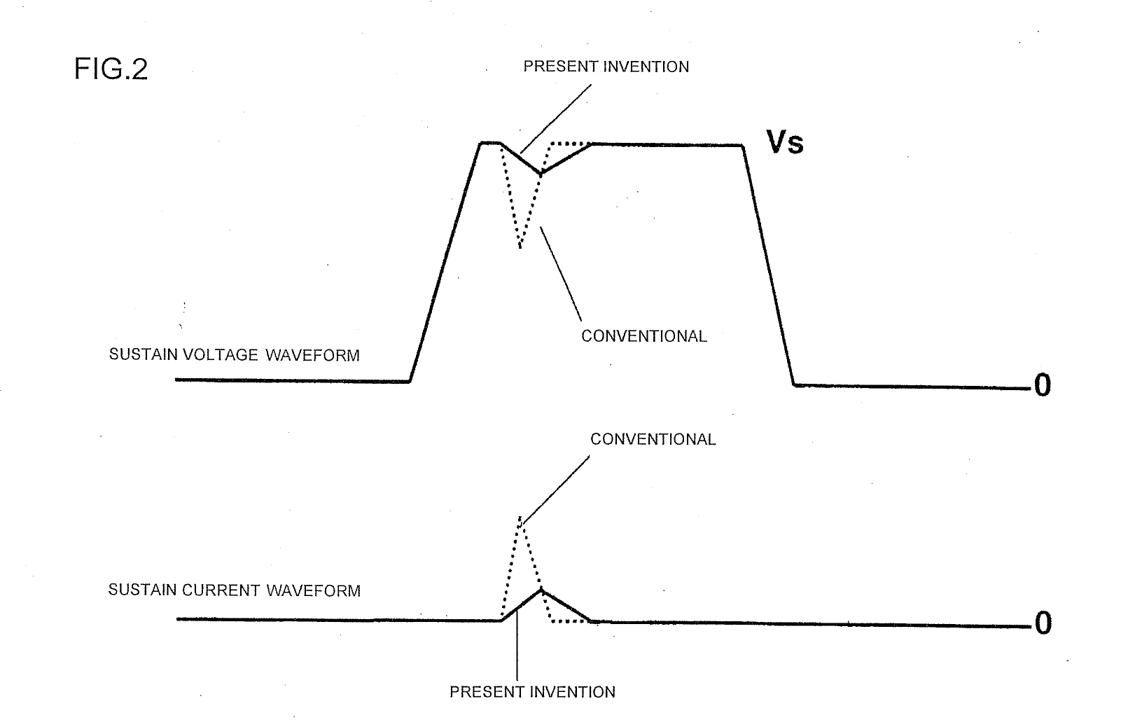

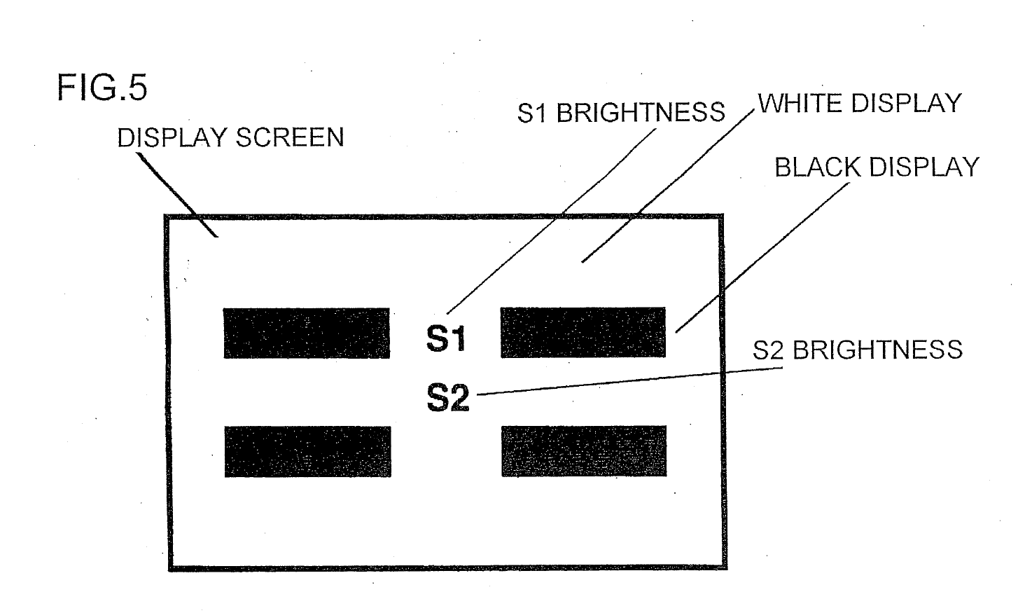

The result is shown in FIG. 2. As shown in FIG. 2, as a result of conducting the experiment with the peak value of a sustain current waveform made small and the voltage drop of the sustain voltage made small, it was able to be confirmed that a difference between a voltage drop ΔVs1 at the display spot S1 shown in FIG. 5 and a voltage drop ΔVs2 at the display spot S2 was also reduced, and the value of a streaking was able to be reduced.

As a result of the experiment, it was confirmed that in the case of using the large-sized plasma display panel 7 of the 55-model class, by setting the value of the resistance of the above described current limiting means 8x and 8y at 10 to 20 106 , the value of a streaking of about 8% was reduced to about 4%, and the improvement effect by about 4% was confirmed.

The resistance of each of the X-electrode and Y-electrode in the above described plasma display panel 7 is about 50 Ω, and therefore, the resistance value which is used as the above described current limiting means 8x and 8y corresponds to 20% to 40% of the resistance value of each of the X-electrode and Y-electrode.

As the above described current limiting means 8x and 8y, any means that limit the current such as a semiconductor can be replaced with the resistor, and for example, a diode or the like may be used. The diode for limiting a current may be formed inside the plasma display panel 7.

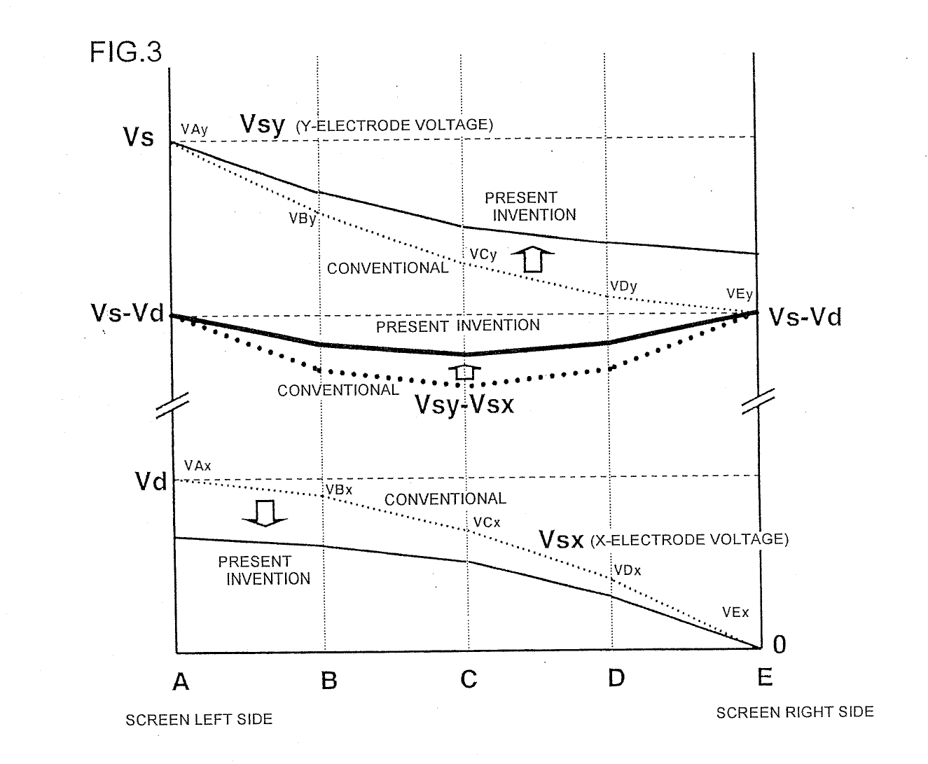

By using the above described current limiting means 8x and 8y, the voltage drop in the central portion of the screen which is caused by the above described sustain current can be reduced. As shown in FIG. 3, in the present invention, the voltage drop of the Y-electrode voltage Vsy is reduced, and the voltage drop in the inverse direction of the X-electrode voltage Vsx is also reduced. Thus, a voltage (Vsy-Vsx) at the time of discharge between the X-electrode and the Y-electrode in each of the cells is reduced, and relative reduction in the discharge voltage (VCy-VCx) between the X-electrode and the Y-electrode in the central portion of the screen can be reduced, and the brightness difference between the central portion of the screen and the two ends of the screen can be reduced.

In this embodiment, the case of using the resistors having the same value as the current limiting means 8x and 8y is described, but the invention of the present application is not limited to this, and it is obvious that in the case of using the resistors having different values, the effect of reducing a streaking can also be obtained.

### Second Embodiment

Considering the balance of disposition relationship of the current routes to the X-electrode and the Y-electrode of the plasma display panel 7 in the X-electrode drive circuit 3 and the Y-electrode drive circuit 4, in the case of providing the current limiting means 8x and 8y for each electrode, the current routes in the upper and the lower portions of the screen become longer as compared with the current route in the central portion of the screen, and therefore, the voltage drop of the sustain voltage in the upper and lower portions of the screen becomes large, as a result of which, a brightness difference is likely to occur between the upper and lower portions of the screen, and the central portion of the screen.

In this case, the current limit value of each of the current limiting means 8x and 8y is set at a different value in each of the electrode. For example, the current limit values of the current limiting means 8x and 8y are made smaller toward the upper and lower portions, and a difference in voltage drop in accordance with the difference in the length of the above described current route can be corrected.

Therefore, in the plasma display device of the present invention, the brightness difference between the central portion of the screen and the two ends of the screen is reduced, and the brightness difference between the upper and lower portions of the screen and the central portion of the screen can be reduced.

### Other Embodiments

Hereinafter, configuration examples of the present invention are described in additions.

### Addition 1

An AC-type plasma display device including a plasma display panel, an X-electrode drive circuit which drives a plurality of X-electrodes of the plasma display panel, a Y-electrode drive circuit which drives a plurality of Y-electrodes of the plasma display panel, and an address electrode drive circuit 5 which drives a plurality of address electrodes of the plasma display panel, characterized by including:
current limiting means interposed for each X-electrode between the X-electrode and the X-electrode drive circuit; and/or
current limiting means interposed for each Y-electrode between the Y-electrode and the Y-electrode drive circuit, and characterized in that
an impedance of the current limiting means is 20% to 40% of a resistance value of each of the electrodes.

### Addition 2

The AC-type plasma display device according to the addition 1, characterized in that the X-electrode drive circuit is divided into an odd-numbered X-electrode drive circuit which drives odd-numbered X-electrodes, and an even-numbered X-electrode drive circuit which drives even-numbered X-electrodes, and the Y-electrode drive circuit is divided into an odd-numbered Y-electrode drive circuit which drives odd-numbered Y-electrodes, and an even-numbered Y-electrode drive circuit which drives even-numbered Y-electrodes.

### Addition 3

The plasma display device according to the additions and 2, characterized in that
the current limiting means is composed by using a resistor.

### Addition 4

The plasma display device according to the additions and 2, characterized in that
the current limiting means is composed by using a semiconductor.

### Addition 5

The plasma display device according to the addition 4, characterized in that
the current limiting means is composed by using a diode.

### Addition 6

The plasma display device according to the addition 5, characterized in that
the current limiting means is composed by using diodes formed on the X-electrode and the Y-electrode of the plasma display panel.

### Addition 7

The plasma display device according to the additions to 3, characterized in that
the current limiting means is formed in a scan driver module connected between the plasma display panel and the Y-electrode drive circuit.

### Addition 8

The plasma display device according to the addition 7, characterized in that
the current limiting means is formed in a semiconductor integrated circuit composing a scan circuit packaged in the scan driver module.

### Addition 9

The plasma display device according to the additions to 3, characterized in that
the current limiting means is formed on a relay board connected between the plasma display panel and the X-electrode drive circuit.

### Addition 10

The plasma display device according to the additions to 3, characterized in that
the current limiting means is formed on a flexible board connected between the plasma display panel and the X-electrode drive circuit, or is formed on a flexible board connected between the plasma display panel and the Y-electrode drive circuit.

### Addition 11

The plasma display device according to the additions 1 to 10, characterized in that
a current limit value of the current limiting means is set to be large in a central portion of a screen and to be small in an upper and lower portions of the screen.

### Addition 12

The plasma display device according to the addition 3, characterized in that
a resistance value of the resistor used as the current limiting means is set to be large in a central portion of a screen, and to be small in an upper and lower portions of the screen.

### Addition 13

The plasma display device according to the addition 11, characterized in that
the current limit value of the current limiting means is set to be gradually smaller toward the upper and lower portions from the central portion of the screen.

### Addition 14

The plasma display device according to the additions 4 and 5, characterized in that
a forward voltage drop of the diode used as the current limiting means is large in a central portion of a screen, and is small in an upper and lower portions of the screen.

### Addition 15

The plasma display device according to the addition 14, characterized in that
the forward voltage drop of the diode used as the current limiting means becomes gradually smaller toward the lower portion from the central portion of the screen.

### Addition 16

The plasma display device according to the addition 9, characterized in that
a current limit value in the current limiting means is set so that a voltage drop by wiring on the relay board connected between the plasma display panel and the X-electrode drive circuit becomes substantially equal in an end portion of the plasma display panel.

### Addition 17

The plasma display device according to the addition 10, characterized in that
a current limit value in the current control means is set so that a voltage drop by wiring of the flexible board becomes substantially equal in an end portion of the plasma display panel.

### Addition 18

The plasma display device according to the addition 2, characterized in that
a panel of an ALIS (Alternate Lighting of Suefaces Method) structure is used for the plasma display panel.

### Addition 19

The plasma display device according to the addition 2, characterized in that
a panel of an e-ALIS (extended Alternate Lighting of Suefaces Method) structure is used for the plasma display panel.

### Addition 20

The plasma display device according to the addition 19, characterized in that
a screen size of the plasma display panel is of a 55-model or larger.

1. An AC drive type plasma display device comprising a plasma display panel, a first electrode drive circuit which drives a plurality of first electrodes of the plasma display panel, a second electrode drive circuit which drives a plurality of second electrodes of the plasma display panel, and an address electrode drive circuit which drives a plurality of address electrodes of the plasma display panel, characterized by comprising:
current limiting means interposed for each first electrode between the first electrode and the first electrode drive circuit; and/or
current limiting means interposed for each second electrode between the second electrode and the second electrode drive circuit.

2. The plasma display device according to claim 1, characterized in that
an impedance value of the current limiting means is 20% to 40% of a resistance value of each of the electrodes.

3. The plasma display device according to claim 1, characterized in that
the first electrodes are X-electrodes composed of odd-numbered X-electrodes and even-numbered X-electrodes,
the second electrodes are Y-electrodes composed of odd-numbered electrodes and even-numbered electrodes,
the first electrode drive circuit is divided into an odd-numbered X-electrode drive circuit which drives the odd-numbered X-electrodes and an even-numbered X-electrode drive circuit which drives the even-numbered X-electrodes, and
the second electrode drive circuit is divided into an odd-numbered Y-electrode drive circuit which drives odd-numbered Y-electrodes, and an even-numbered Y-electrode drive circuit which drives the even-numbered Y-electrodes.

4. The plasma display device according to claim 3, characterized in that
the current limiting means is composed by using a resistor.

5. The plasma display device according to claim 3, characterized in that
the current limiting means is composed by using a semiconductor.

6. The plasma display device according to claim 5, characterized in that
the current limiting means is composed by using a diode.

7. The plasma display device according to claim 6, characterized in that
the current limiting means is composed by using diodes formed on the X-electrode and the Y-electrode of the plasma display panel.

8. The plasma display device according to 3, characterized in that
the current limiting means is formed in a scan driver module connected between the plasma display panel and the Y-electrode drive circuit.

9. The plasma display device according to claim 8, characterized in that
the current limiting means is formed in a semiconductor integrated circuit composing a scan circuit packaged in the scan driver module.

10. The plasma display device according to claim 3, characterized in that
the current limiting means is formed on a relay board connected between the plasma display panel and the X-electrode drive circuit.

11. The plasma display device according to claim 3, characterized in that
the current limiting means is formed on a flexible board connected between the plasma display panel and the X-electrode drive circuit, or is formed on a flexible board connected between the plasma display panel and the Y-electrode drive circuit.
